(19) United States
(12) Patent Application Publication
(10) Pub. No.: US 2015/0108195 A1
(43) Pub. Date: Apr. 23, 2015

(54) Method and Device for the Fracture Separation of a Workpiece

(71) Applicant: Mauser-Werke Oberndorf Maschinenbau GmbH, Oberndorf (DE)

(72) Inventors: Siegfried Gruhler, Vohringen-Wittershausen (DE); Helmut Kutz, Dornhan (DE); Horst Schöllhammer, Epfendorf-Trichtingen (DE); Matthias Drinkmann, Deisslingen (DE)

(73) Assignee: Mauser-Werke Oberndorf Maschinenbau GmbH, Oberndorf (DE)

(21) Appl. No.: 14/384,788

(22) PCT Filed: Mar. 12, 2013
(86) PCT No.: PCT/EP2013/054931

§ 371 Date: Nov. 7, 2014

(30) Foreign Application Priority Data
Mar. 12, 2012 (DE) 10 2012 102 053.1
Dec. 18, 2012 (DE) 10 2012 112 539.2

(51) Int. Cl. F16C 9/04; F16C 7/02; B23D 31/00

(52) U.S. Cl. CPC F16C 9/045; B23D 31/003; F16C 7/023
USPC 225/1; 225/96; 74/579 E

(57) ABSTRACT

A method and a device for fracture separation of a workpiece and a workpiece fracture-separated by the method in accordance with the invention or with the device in accordance with the invention are disclosed. According to the invention, at a distance from a fracture separating notch at least one fracture directing notch is formed, which plays a part in determining the path followed by the fracture separating plane. The device for the fracture separation of the workpiece has a laser unit for forming the fracture separating notch and a mechanical machining unit for forming the fracture directing notch.

### BACKGROUND OF THE INVENTION

1. Field of the Invention

The invention relates to a method for fracture separation of a workpiece in accordance with the preamble of claim 1, a device for fracture separation of a workpiece as well as a workpiece fracture separated according to the method or by way of the device.

2. Description of Related Art

EP 0 808 228 B2 of Applicant describes a generic fracture separation method in which in a bearing eye to he fracture separated, e.g. a connecting rod eye, a notch defining the fracture separating plane is formed by way of laser energy. The notch consists of a plurality of notch sections the distance of which essentially results from the pulse rate of the laser and the feed rate of the laser beam with relation to the connecting rod eye. It turned out that by such notch sections the notch factor can be increased considerably vis-à-vis full-length notches, so that the formation of a notch and an optimized fracture separating plane is made possible with comparatively low laser power, By way of the low laser power and a resulting little amount of heat applied to the workpiece undesired deep micro structural changes in the notch area are avoided, specific edges of the notch being subjected to a micro-structural transformation, thereby improving the fracture separation behavior,

DE 2005 031 335 A1 of Applicant describes an improved method in which the notch is not formed in a linear, but approximately sinus-shaped manner with linear end sections. Surprisingly, it turned out that by such a configuration of the notches the fracture separation method may be further improved.

DE 10 2010 014 085 A3 of Applicant describes a method in which laser type, pulse rate, workpiece material, and laser power are synchronized so that the distance of the above-described notch portions is considerably larger than the calculated distance resulting from the feed rate, relative movement and pulse rate of the laser. Such a behavior may be set, for example, using a fiber laser. Such fiber lasers basically may be diode-pointed solid-state lasers, the core of a glass fiber forming the active medium. Via coupling, radiation of the solid-state laser is introduced into the fiber in which the actual laser gain takes place. The properties and quality of the laser beam can be adjusted via the geometry of the fiber, so that the laser for the most part remains independent of external influences and shows a very simple structure.

After exit of the above-indicated active fiber the laser beam is introduced into a glass fiber through which the beam is then led to the actual laser head and directed to the workpiece to be machined via an optical focusing unit. Such fiber lasers are characterized by very high electro-optical efficiency and excellent beam quality in a very compact structure, so that with little installation space less expensive solutions than with conventional lasers may be provided,

The aforementioned methods and devices are used very successfully in the fracture separation of the most diverse workpieces made of steel alloys.

Particularly in the automotive industry efforts are made to the effect that light constructional components are used so as to reduce the power/weight ratio of vehicles as well as fuel consumption. Also in engine construction light metal alloys are used. Thus, connecting rods of aluminium and titanium are intended to be used, in internal combustion engines.

Since the afore-described methods for the fracture separation of a connecting rod eye into a bearing shell and a connecting rod-side part has gained acceptance in engine manufacture on account, of the well controllable technology and comparatively low investment costs, the method also is to be used for such light metal construction connecting rods. However, it turned out that conventional methods are not suited to fracture separate e.g. aluminium connecting rods with the desired precision since preliminary tests showed that the fracture separation plane is not in the predefined area, but runs out, resulting in so-called cup-and- cone fractures in which the fracture separating plane runs toward a bolt or screw hole of the connecting rod, so that in the area of the bolt or screw hole a conical projection results in one fracture-separated past and a corresponding conical funnel or cup in the other fracture-separated part. Such a cup-and-cone fracture, however, is not at all acceptable as the joining behavior of the fracture-separated parts is insufficient. Such a fracture behavior was to be observed especially in case of forged aluminium connecting rods since such connecting rods typically have very low silicon content. In case of cast aluminium connecting rods such uudesired fracture behavior occurs to a lesser extent as the content of silicon is higher. Similar problems are to be observed in connecting rods of titanium.

### SUMMARY OF THE INVENTION

As opposed thereto, the invention is based on the object of providing a method and a device for the fracture separation of a workpiece and a workpiece, that ensures improved fracture behavior even in using a light metal construction material such as, for example, aluminium alloys or titanium alloys, fracture-tough material, or in a surface treatment that adversely influences the fraction behavior in conventional fracture separation methods.

The object is solved with regard to the method by the feature combination of claim 1, with regard to the device by the feature combination of independent claim 13, and with regard to the workpiece by the feature combination in accordance with independent claim 10.

Further advantageous features of the invention are dealt with in the sub-claims.

The method in accordance with the invention is intended for the fracture separation of a workpiece along a bearing eye, diametrically arranged fracture separating notches that approximately define a fracture separating plane, being formed on the bearing eye in a circumferential wall thereof. Fracture separation is then performed by way of a crack mandrel that is inserted in the bearing eye and is expanded radially so as to apply a fracture separating force to the bearing eye. In accordance with the invention, at a distance from the fracture separating notches, at least one fracture directing notch is formed, which plays a part in determining the path followed by the fracture separating plane. In accordance with the invention, the fracture directing notch is formed such that the fracture separating plane is in the predetermined area, so that an emergence of cup-and-cone fractures or the like can be avoided even in fracture-tough materials such as light metal alloys,

The fracture directing notch in accordance with the invention offers excellent protection against fracture misdirection. Such fracture misdirection may occur, for example, in a workpiece with threaded hole. In case the threaded hole is formed as a through-hole and the threads are comparatively close to the desired fracture separating plane, the fracture may run in the direction of the thread, thus not exhibiting the predetermined path. On account of the resulting damage of the thread the workpiece becomes useless. In workpieces with tapped blind holes so-called retraction marks may occur during thread cutting. In fracture separating such a workpiece it may likewise occur that the fracture separating plane is misdirected on account of such retraction marks. All those misdirections may be avoided by way of a fracture directing notch.

Particularly in forged workpieces in which the forging skin is cold-hardened e.g. by shot peening, the fracture separating notch on the outer circumference offers protection against misdirections. Such forged connecting rods with cold-hardened forging skin are used, for example, in high-performance engines. Without such a fracture separating/fracture directing notch the fracture separating plane in the area of the strain hardened forging skin in such a workpiece would deviate from the desired path (misdirection).

The workpiece in accordance with the invention is manufactured using such a method. The device for performing such method in particular has a laser unit for forming a fracture separating notch, a crack unit and a machining unit for forming the at least one fracture directing notch, the machining unit preferably being a mechanical machining unit.

In one embodiment, the fracture directing notch is formed in a cutting manner. As an alternative, the fracture directing notch may, of course, also be formed in a different way, e.g. by laser energy or by transforming, by forging, for example. In such a forging process the workpiece is compressed in the desired area, so that a fracture directing notch is formed. The fracture directing notch may also be formed electrochemically (electrochemical machining). In such a process, an electrode and the workpiece are received by an electrolyte. In applying a voltage the workpiece is then skimmed locally, the skimming geometry depending on the geometry of the electrode. The voltage may be applied as direct voltage or pulsed for increasing precision.

The method in accordance with the invention is used in particular in workpieces, e.g. in threaded holes, which, in the area of the envisaged fracture separating plane, have an opening on the circumference of which the fracture directing notch is then formed.

The fracture separating notches preferably are incorporated in the manner described above by laser energy, preferably by means of a fiber laser.

The fracture separating behavior may be further improved when the fracture separating notches are formed on the bearing eye circumferentially.

For a circumferential formation, either the laser and/or the workpiece may be pivoted around a pivot axis,

In an embodiment it is preferred to form each of the fracture separating notch and/or the fracture directing notch by a plurality of notch sections that complement each other to form the fracture separating notch.

In a modification of the invention the workpiece is a connecting rod the connecting rod eye of which is fracture separated into a bearing shell and a connecting rod-side part. In doing so, on the circumferential wall of the bearing eye the fracture separating notches are formed diametrically to one another and a fracture directing notch is formed in each of the bolt/screw holes of the connecting rod. However, the invention on no account is restricted to the application in connecting rods, but may also be used in other workpieces to be fracture separated in which, for example, a bearing cap is to be separated from a block or the like. Such definitions of tasks arise, for example, in crankcases, camshaft cases, etc.

The fracture behavior may be further improved if the workpiece, prior to the actual

fracture separating, is treated thermally, at least partially in the area of tire fracture separating notch and/or fracture directing notch.

In a conventional manner, fracture separation maybe performed by the so-called shock or impact cracking, a fracture separating force being applied to an expanding mandrel, which suffices to initiate cracking. As an alternative, also the so-called fatigue cracking or crack propagation cracking can be performed in which an alternating dynamic force is applied to the expanding mandrel overlaying the fracture separating force or being prior to the fracture separating force, so that a fatigue crack is formed. Such method is of advantage particularly in very fine surface structures. Details of the method are disclosed in DE 10 137 975 A1 of Applicant.

Furthermore, the fracture separating behavior may also be improved in that the fracture separating notches and/or the fracture directing notches are performed not in an approximately linear manner, but with sections (bulges) that are inclined across their longitudinal direction, so that in the first approximation a sinusoidal or zigzag-shaped fracture separating notch geometry is formed. Thereby, a wavy crack initiation area is formed during fracture separation, which enables reliable pre-centering of the fracture separated parts of fee workpieces, e.g. during bolting or screwing at a later stage.

Such a form laser notch is disclosed, for example, in DE 10 2005 031 335 A1 of Applicant.

In using an aluminium alloy, thermal treatment takes place by heating fee workpiece. The heating may be done e.g. by laser energy and/or via a suitable method, e.g. induction.

The device in accordance with the invention may be configured with a turning table for the workpiece, wherein an associated laser itself can be implemented with a pivot axis.

The cycle rimes can be reduced when a workpiece is machined with two laser units,

As was already indicated, a combination of fracture directing notch and fracture separating notch is of advantage in specific materials (light metal alloys (such as Ti, Al alloys), fracture tough material, material with cold-hardened outer skin) and/or in workpieces that involve the risk of misdirection through the choice of material, surface treatment or the geometry, e.g. through threaded holes crossing the fracture separating plane.

These and other features and advantages of the invention will become apparent to those skilled in the art from the following description and the accompanying drawing. It should be understood, however, that the detailed description and specific examples, while indicating a preferred embodiment of fee present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

A preferred embodiment of the invention is explained in more detail in the following by way of schematic drawings.

FIG. 1 shows a three-dimensional representation of a forged aluminium connecting rod;

FIG. 2 is a cross-sectional view of the connecting rod shown in FIG. 1;

FIG. 3 shows the path of a fracture separating plane after fracture separation of the workpiece in accordance with FIG. 1;

FIG. 4 is a schematic diagram of a laser unit of the device in accordance with the invention with which two fracture separating notches in the connecting rod of FIG. 1 are formed;

FIG. 5 is a modification of the device of FIG. 4, and

FIGS. 6 and 7 constitute embodiments of a connecting rod with form laser notches.

### DETAILED DESCRIPTION OF THE DRAWINGS

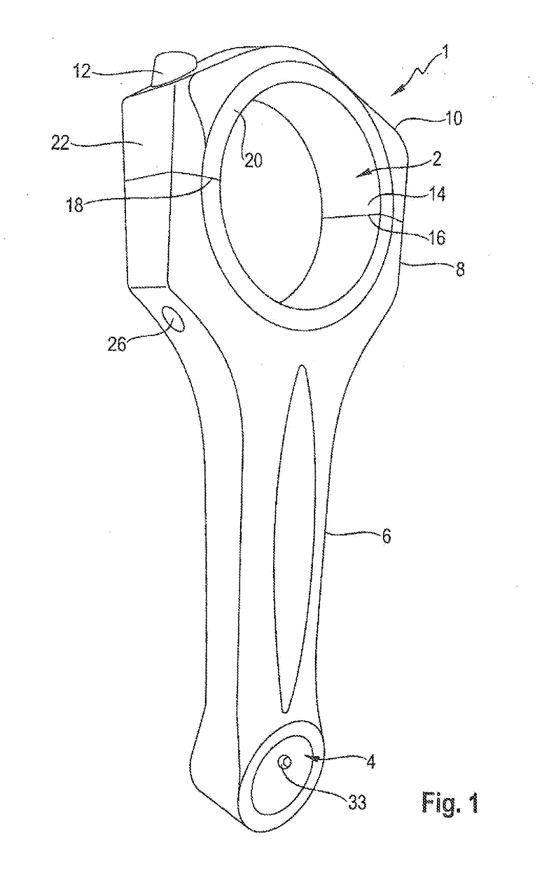

The connecting rod 1 of an internal combustion engine depicted in FIG. 1 consists of an aluminium alloy, winch has a comparatively high proportion of silicon, for example, between 0.3 and 2 percent by weight, and thus, as was explained at the beginning, causes difficulties in conventional cracking as cup-and-cone fractures may occur.

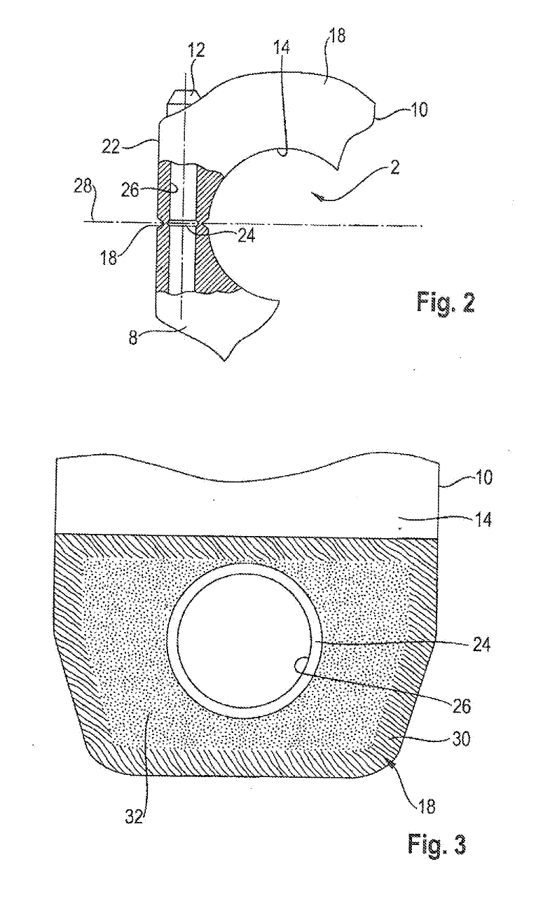

Similar to steel connecting rods, the aluminium connecting rod 1 has a large connecting rod eye 2 and a small connecting rod eye 4 between which a connecting rod 6 extends. Through the fracture separation process (cracking) described in the following the connecting rod is to be fracture separated into a connecting rod-side part 8 and a bearing shell 10 in the area of the large connecting rod eye 2. After fracture separation, the two elements are joined again and fastened by way of two bolts/screws 12 of which merely one is to be seen in the representation in accordance with FIG. 1. The bolts/screws 12 can be conventional steel bolts/screws. As in the conventional method the fracture separating plane is defined by diametrically arranged fracture separating notches in the circumferential wall 14 of the large connecting rod eye 2, However, in contrast to the conventional solution, the fracture separating notches 16, 18 are not only formed in the area of the circumferential wall 14, but are formed circumferentially, i.e. the fracture separating notches 16, 18 extend along the circumferential wall 14 and along an adjacent front surface 20, a respective lateral surface 22 and the rear end face not shown in FIG. 1, so that the entire circumferential surface of the respective web of the connecting rod eye is encompassed. Preliminary tests have shown, however, that such a circumferential fracture separating notch not always suffices to prevent the emergence of cup-and-cone fractures. Correspondingly, in accordance with the invention, a fracture directing notch 24 is formed at a distance from the respective circumferential fracture separating notch 16, 18. Such fracture directing notch is shown in the cross-sectional view of FIG. 2, which shows a vertical cross-section of the in FIG. 1 left portion of the large connecting rod eye 2. In this partial section, a bolt/screw hole 26 filled by the bolt/screw 12 is to be discerned, the bolt/screw being omitted in the area of the sectional view of the bolt/screw hole 26 in FIG. 2. In the plane defined by the circumferential fracture separating notch 18, which. lies in the dot-dashed fracture separating plane 28, the fracture directing notch 24 is formed. The fracture directing notch thus forms a circumferential recess in bolt/screw hole 26. Such recess is formed preferably mechanically, e.g. by way of a recessing tool and thus by circular recessing/turning. The angle of the cutting edge of the recessing tool with regard to the circumferential wall of the bolt/screw hole 26 may amount to approximately 60° to 90°.

For such mechanical machining, a machining unit with four spindles may be provided, for example, with which it is possible to machine several connecting rods and/or both bolt/screw holes at the same time. In this connection, it is preferred that the machining unit is configured using an inverse construction method, wherein spindles are located fixed in place while the workpiece performs the relative movements to the spindles required for machining.

In accordance with the invention, a fracture directing notch 24 is formed in the area of the intended fracture separating plane 28 and at a distance from the fracture separating notch 16, 18, so that an emergence of cup-and-cone fractures may be prevented reliably. In the embodiment in accordance with the invention, the fracture separating notches 16, 18 e.g. are incorporated by laser energy according to the methods explained in the introductory portion of the description, preferably by using a fiber laser, so that thermal strain and thus a transformation in the micro-structure is kept at a minimum in the area of the fracture separating notch.

FIG. 3 shows a typical path followed by the fracture plane, which ensues in applying the method in accordance with the invention. What is shown is e.g. the fracture plane in the area of the web of the connecting rod eye of bearing shell 10 depicted in FIG. 2. The bolt/screw hole 26 and the bearing shell-side part of the fracture directing notch 24 formed in the circumference of bolt/screw hole 26 are to be discerned, the fracture directing notch forming a kind of chamfer after fracture separation. What also is clearly visible is the circumferential fracture separating notch 18 that is manufactured by way of a fiber laser. As was described at the beginning, the fracture separating notch 18 consists of a plurality of notch sections 30 spaced apart to one another. In the depicted embodiment the laser beam is coupled at an angle of 30°, i.e. in a slanting way to the circumferential plane. Naturally, other coupling angles may also be realized.

It is to be seen in the representation that the actual fracture separating plane 32 runs very smoothly from the circumferential fracture separating notch 18 to the inner fracture directing notch 24—not even the beginning of a cup-and-cone fracture is to be determined.

In principle, the formation of the fracture directing notch 24 may be performed by laser energy, or in a different manner. It is, for example, conceivable to form the fracture directing notch 24 by specifically compressing the material in this area, so that the fracture directing notch 24 virtually arises by way of a concave surface in the area of the bolt/screw hole formed by the compression. Such a compression process is described, for example, in DE 43 03 592.

The process of fracture separation and hence the quality of the fracture separating plane may be further improved if the connecting rod, prior to fracture separation, is at least partially heated in the area of the intended fracture separating plane 28. In so doing, the particular feature of some aluminium alloys in which fracture toughness decreases with increasing temperature is taken advantage of. Steel alloys exhibit just an opposite behavior, in those alloys fracture toughness increases with increasing temperature. The heating may be performed inductively, for example. In principle, it is also possible to perform the heating additionally or, as an alternative, by way of a laser.

Correspondingly, in oilier alloys fracture toughness can be reduced in that the respective workpiece is partially cooled down.

Fracture separation of a connecting rod can be executed by way of the device in accordance with the invention, which may include a plurality of machining units that are spaced apart locally from one another, or else may be integrated in one system. What is basically required is a laser unit for insertion of the fracture separating notches 16, 18, a crack unit for fracture separation and a joining unit for joining the fracture separated elements by inserting or tightening the bolts/screws 12, which may remain in the connecting rod during fracture separation. What is further required is a mechanical machining unit for forming the fracture directing notches 24, such machining unit preferably not being integrated in the actual fracture separation unit, but implemented as an inverse machine or the like. In the machine also an oil hole 33 (see FIG. 1) could be formed in the small connecting rod eye.

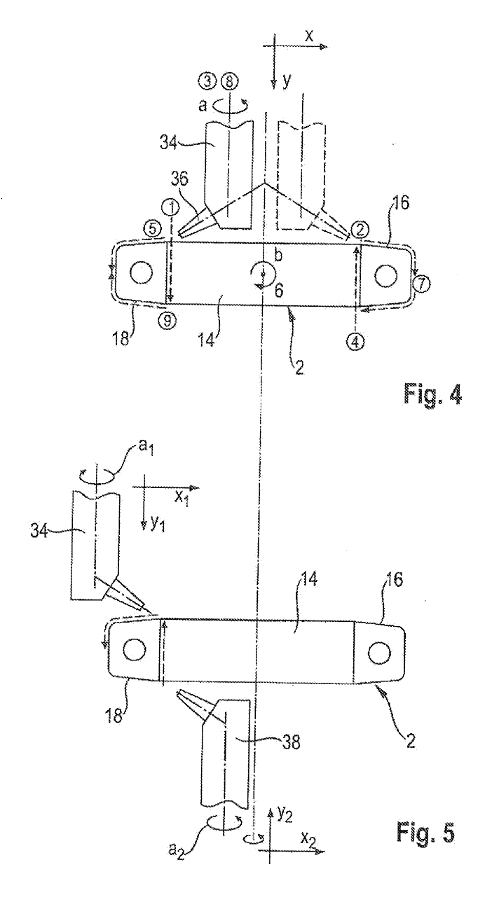

In accordance with FIG. 4 the actual laser unit comprises a fiber laser of the construction type described initially, in the laser head 34 of which a focusing optics is located, so that the laser beam 36 is coupled at a predefined angle relative to the machined surface. In the depicted embodiment the angle amounts to approximately 30°.

The laser head may be revolved around its vertical axis a (see the dashed representation in FIG. 4). Furthermore, the laser head 34 is located on a guide via which it is movable in an x and y direction. The connecting rod of which merely a cross-section of the large connecting rod eye 2 is visible, in the depicted embodiment is located on a turning table, which in turn can be pivoted around an axis b, the pivot axis being perpendicular to the drawing plane. As an example, FIG. 4 shows one possibility of a plurality of possibilities for the formation of circumferential fracture separating notches 16, 18. At the beginning of the machining process laser head 34 is put into position “1” shown in FIG. 4 and then moved along the y axis, so that the section of the fracture separating notch is formed that lies in the circumferential surface 14. The laser head 34 is then moved back into its initial position and moved in an x direction into the position marked by “2”, thus forming the circumferential section of the other fracture separating notch 16, which in FIG. 4 is depicted in the upper right area. After this step, the laser head 34 is moved into the position marked by dashed lines and pivoted around axis a by 180°, so that the section of fracture separating notch 16 that lies in the circumferential surface 14 is formed (“4”); this may be done in the direction of the arrow in accordance with FIG. 4, either in a towing manner, or by recessing from top to bottom. Subsequently, the laser head 34 is moved to the left along the x, y guide and, in accordance with “5”, the upper circumferential section of the other fracture separating notch 18 is formed.

In a subsequent step “6” the connecting rod Is turned around axis b by 180° and the in FIG. 4 lower circumferential section of the fracture separating notch 16, which after turning of the turning table becomes the upper left circumferential section, is then formed—the fracture separating notch 16 is then completed. After the step “7” the laser head 34 is then pivoted back into its original position (step “8”) and the remaining surface section of fracture separating notch 18 is machined, which in the afore-described pivot position of the turning table in the representation of FIG. 4 is in a top right position. This step is marked by “9” in FIG. 4. This means, that simply by pivoting the connecting rod and the laser the two circumferential fracture separating notches 16, 18 may be formed comparatively quickly. Naturally, other sequences of operation can be realized.

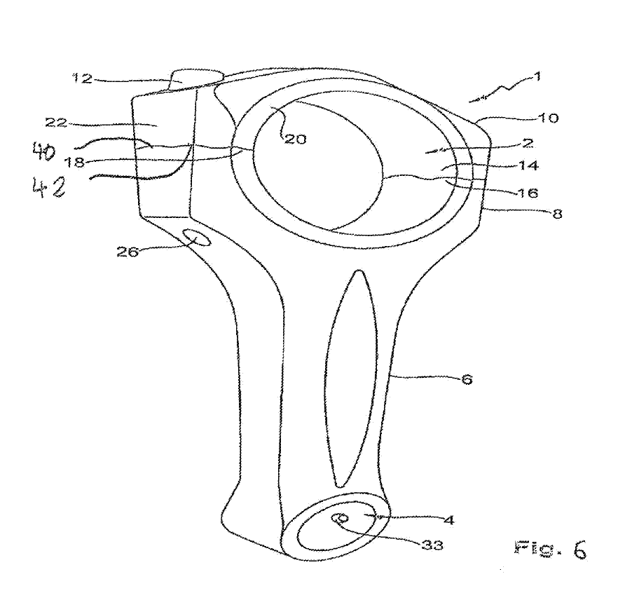

FIG. 5 shows an alternative in which the formation of the fracture separating notches 16, 18 can be performed considerably quicker. In this alternative, in addition to the one laser with laser head 34, a further laser unit with a laser head 38 is provided. Similar to the embodiment described before, the laser can be pivoted around a vertical axis m and moved in an x₂, y₂ direction. With such an arrangement it is possible, for example, to form two respective circumferential sections of the respective laser notches 16, 18 at the same time. In a relative position of laser heads 34, 38 in FIG. 5 the upper left portion of fracture separating notch 18 is thus formed via laser head 34, while laser head 38 forms the area of laser notch 18 that lies in circumferential surface 14. Of course, the configuration could also be controlled so that the one laser head 34 machines the one fracture separating notch 18, and the other laser head 38 machines the other fracture separating notch 16.

As mentioned before, the method and the device in accordance with the invention (laser unit, mechanical machining unit for fracture directing notch 24) may also be used for machining other workpieces in which an opening or the like is formed in the area of the fracture separating plane at a distance from the fracture separating notch, which opening makes it possible to form a fracture directing notch at a distance from the fracture separating notch. Also the workpiece can be pivot mounted along an x, y guide.

Furthermore, the setting behavior of the fracture plane may be improved by partial laser radiation.

Conventionally, fracture separation may be carried out by the so-called shock, or impact cracking, in which the fracture separating force being applied to an expanding mandrel is increased until a crack arises. As was explained at the beginning, it is advantageous particularly in very fine structures if the so-called fatigue cracking described in DE 10 137 975 A1 is used, wherein an alternating dynamic force overlaying the fracture separating force or being prior to the fracture separating force is applied to the expanding mandrel via an oscillating system, so that the fracture separating area of the workpiece is caused to vibrate, which then leads to the formation of a fatigue crack.

In the fracture separation of connecting rods or similar workpieces, the fracture separated parts are fastened to one another with screws or bolts after fracture separation. Such fastening may be simplified considerably if the fracture separating notch is formed in a wavy or zigzag-shaped manner, so that displaced sections arise that are transversely to a longitudinal axis of the fracture separating notches. Such sinusoidal or wavy shape runs out in the fracture separating plane away from the fracture separating notch in a more or less linear manner and enables pre-centering of the fracture separated parts. Fine centering is then performed by way of the irregularities in the fracture separating plane that are predetermined by the microstructure.

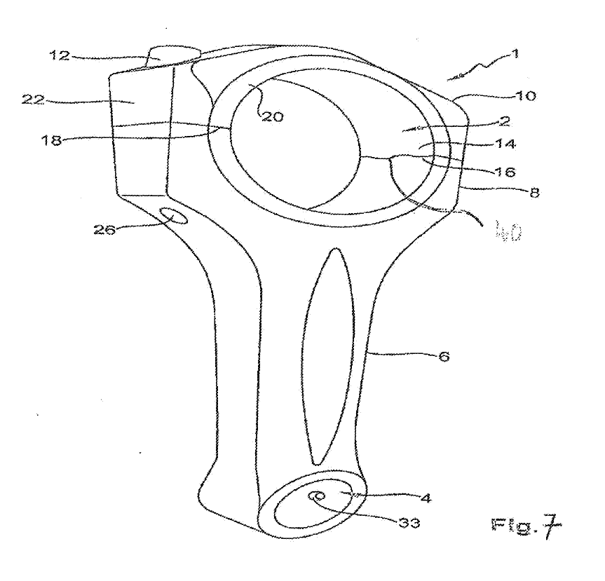

FIG. 6 shows such a “form laser notch” formed for fracture separation of a connecting rod. In accordance with FIG. 6 the fracture separating notches are not formed, as in the embodiment in accordance with FIG. 1, in a linear and circumferential manner, but have a wavy structure that is formed circumferentially. In the depicted embodiment a slight sinus shape was selected, in each wall area (inner circumferential wall, front surface areas and outer circumferential wall) a “wave” 40, respectively deflected to the top or to the bottom, is formed. In accordance with the invention it is thereby preferred that such waves 40 run out in linear sections 42, which in the first approximation lie in a fracture separating plane that would be formed in a linear fracture separating notch geometry. Correspondingly, also the fracture separating notches in the corner areas, i.e. in the transitional areas from fire circumferential wall or the outer circumferential wall to the front-end wall areas, may then be formed linearly. In the area of the inner circumferential surface 14 and the outer lateral surfaces/outer circumferential surfaces those linear sections 42 run approximately parallel to the bearing axis. In principle, it is sufficient if in each surface section of circumferential fracture separating notch 14,16 merely one bulge (wave 42) is formed that, in the representation of FIG. 6 extends to the top or bottom.

FIG. 7 shows an embodiment in which a form laser notch with each of its waveform and the bulges extending to the top and/or bottom is formed merely in the area of the inner circumferential surface 14. The areas of the fracture separating notch on the two front surfaces 20 and on the outer lateral surfaces 22, in accordance with the embodiment of FIG. 1, are formed linearly.

As was mentioned above, in place of the aforementioned approximately sinus shaped bulges 40 also other notch geometries may be used.

A method and a device for fracture separation of a workpiece and a workpiece fracture-separated by the method in accordance with the invention or with the device in accordance with the invention are disclosed. According to the invention, at a distance from a fracture separating notch at least one fracture directing notch is formed, which plays a part in determining the path followed by the fracture separating plane. The device for the fracture separation of the workpiece has a laser unit for forming the fracture separating notch and a mechanical machining unit for forming the fracture directing notch.

Although the best mode contemplated by the inventors of carrying out the present

invention is disclosed above, practice of the above invention is not limited thereto. It will be manifest that various additions, modifications and rearrangements of the features of the present invention may be made without deviating from the spirit and the scope of the underlying inventive concept.

1. A method for fracture separation of a workpiece along a bearing eye, wherein fracture separating notches arranged diametrically to one another are formed in a circumferential wall by way of laser energy, preferably by way of a fiber laser, which fracture separating notches approximately define a fracture separating plane, a crack mandrel being used so as to apply a fracture separating force to the bearing, characterized in that at a distance from the fracture separating notches at least one fracture directing notch is formed that lies in the fracture separating plane, wherein the fracture separating notches are formed circumferentially, and wherein at least one of the fracture separating notch and the fracture directing notch is formed with approximately wavy or zigzag-shaped sections.

2. The method according to claim 1, wherein the fracture directing notch is formed by machining with a cutting tool or electrochemically or by transforming.

3. The method according to claim 1, wherein the workpiece in the area of the fracture separating plane has at least one opening at a circumferential wall of which said fracture directing notch is formed.

4. The method according to claim 1, wherein a laser unit or the workpiece is arranged rotatably relative to the respective other element.

5. The method according to claim 1, wherein the workpiece is partially heated or cooled prior to fracture separation in the area of the fracture separating plane.

6. The method according to claim 1, wherein separation is performed by forming a fatigue crack.

7. The workpiece produced according to the method claim 1, preferably consisting of a fracture-tough material, and/or including a cold-hardened or otherwise pre-treated surface.

8. The workpiece according to claim 7, wherein said workpiece is a connecting rod the large connecting rod eye of which is fracture separated into a bearing shell and a connecting rod-side part, wherein fracture separating notches are formed diametrically to one another on a circumferential wall and wherein a respective fracture directing notch is formed in bolt/screw holes.

9. The workpiece according to claim 8, wherein the fracture separating notch is formed circumferentially.

10. A device for performing the method according to claim 1, including a laser unit for forming a fracture separating notch and a mechanical machining unit for forming a fracture directing notch.

11. The device according to claim 10, wherein the workpiece is located on a turning table, and wherein a laser head is rotatable and/or movable with relation to the workpiece and/or said workpiece is rotatable and/or movable with relation to said laser head.

12. The device according to claim 10, including an oscillating system for applying, during fracture separation, an alternating dynamic force to the expanding mandrel.

13. The device according to claim 10, including a unit for heating or cooling the area of the fracture separating plane.

14. The workpiece according to claim 7, wherein the workpiece is a fracture-tough material including at least one of aluminum alloy and titanium alloy.
